(19) United States
(12) Patent Application Publication
(10) Pub. No.: US 2005/0160805 A1
(43) Pub. Date: Jul. 28, 2005

(54) Air pressure state reporting apparatus and air pressure state reporting method

(75) Inventor: Yuji Taki, Nishikamo-gun (JP)

Correspondence Address: OLIFF & BERRIDGE, PLC, P.O. BOX 19928, ALEXANDRIA, VA, 22320, US

(73) Assignee: TOYOTA JIDOSHA KABUSHIKI KAISHA, Toyota-shi (JP)

(21) Appl. No.: 10/828,302

(22) Filed: Apr. 21, 2004

(30) Foreign Application Priority Data
May 16, 2003 (JP) 2003-138460

(51) Int. Cl. G01M 17/02; E01C 23/00

(52) U.S. Cl. 73/146

(57) ABSTRACT

A wheel-side device transmits wheel information that includes the state of air pressure detected by an air pressure sensor. The information is received by a vehicle body-side device. A value of air pressure is obtained on the basis of the wheel information received by the vehicle body-side device. If during supply of air pressure to the tire, the air pressure value reaches a target value, a lamp provided on the outside of the vehicle body is flickered in a pattern A. Of the air pressure value reaches the target value+α, the lamp is flickered in a pattern B. Therefore, an operating person outside the vehicle will learn about the air pressure of the tire and therefore about the state of operation of supplying air pressure, on the basis of the state of flicker of the lamp.

### INCORPORATION BY REFERENCE

The disclosure of Japanese Patent Application No. 2003-138460 filed on May 16, 2003 including the specification, drawings and abstract is incorporated herein by reference in its entirety.

### BACKGROUND OF THE INVENTION

1. Field of the Invention

The invention relates to an air pressure reporting apparatus and an air pressure reporting method for reporting the state of air pressure in a tire of a vehicle.

2. Description of the Related Art

Japanese Patent Application Laid-Open Publication No. 9-229804 describes an air pressure indicator device that indicates air pressure detected by an air pressure detector device during the supply of air pressure into a tire. Furthermore, Japanese Patent Application Laid-Open Publication No. 2002-19434 and Japanese Utility Model Application Laid-Open Publication No. 63-107208 describe air pressure detector devices that detect air pressure during the supply of air pressure into a tire.

### SUMMARY OF THE INVENTION

It is an object of the invention to provide an air pressure reporting apparatus and an air pressure reporting method capable of reporting the state of air pressure of a tire to the outside.

In accordance with a first aspect of the invention, an air pressure state reporting apparatus is characterized by including an air pressure state detection device that is provided on a wheel and that detects a state of air pressure of a tire of the wheel, and an reporting device that generates report information indicative of an air pressure state based on the state of air pressure detected by the air pressure state detection device, and that reports the report information generated to outside a vehicle.

In the air pressure state reporting apparatus of this aspect, the report information is generated on the basis of the state of air pressure detected by the air pressure state detection device, and is reported to outside the vehicle. The air pressure state detection device may be a device that directly detects the air pressure of the tire of a wheel. Therefore, the air pressure state detection device is able to accurately detect the tire air pressure and make the detected air pressure known. The air pressure state detection device may also be a device that continuously detects the value of air pressure, or a device that detects the air pressure stepwise. That is, the air pressure state detection device may be a device that performs detection in two or more stages, that is, detects whether the air pressure is higher than a set pressure value provided for each one of the stages.

The report information is information generated on the basis of the state of air pressure detected by the air pressure state detection device, and may be information generated on the basis of the state of air pressure and a state of the wheel that is different from the state of air pressure. For example, the report information may be information that indicates the state of air pressure corresponding to a standard tire temperature which is obtained on the basis of the state of air pressure detected by the air pressure state detection device and the tire temperature (e.g., the temperature of the tire itself, or the temperature of air within the tire). Furthermore, if the air pressure state detection device is a device that detects the value of air pressure, the report information may be information that indicates the detected value of air pressure, information that indicates whether the air pressure value is greater than or equal to a set pressure, and the like.

The reporting device reports the report information. If the reporting device includes a display, a voice generating device, etc., the content of air pressure state report information can be directly reported. Conversely, if the reporting device does not include a display, a voice generating device, etc., the reporting device may include an reporting portion that is operated in a pattern that is determined corresponding to the content of the report information. The reporting portion may be a light radiation device that radiates light in a pattern corresponding to the report information, or a sound generating device that generates a sound in a pattern corresponding to the report information. The report information is reported to outside the vehicle. That is, the report information is reported so that a person outside the vehicle can recognize the information. It is not critical whether or not the reported information is recognizable to a person being within the vehicle.

In the above-described aspect, the reporting device may include an report information generating portion that generates the report information, and an reporting portion that is operated in accordance with the report information generated by the report information generating portion.

In the above-described aspect, the reporting portion may include at least one of a light radiation device that radiates light to outside the vehicle, a sound generating device that generates a sound to outside the vehicle, and a portable instrument that is separate from the vehicle.

The reporting device may be a device that reports the air pressure state information in such a fashion that the information is visually recognizable to a person being outside the vehicle, or a device that reports the air pressure state information in such a fashion that the information is auditorily recognizable, or a device that reports the information in such a fashion that it is recognizable by other senses. For example, if light is radiated to outside the vehicle, a person outside the vehicle can visually recognize the information. If sound is generated, a person outside the vehicle can auditorily recognize the information. If a portable instrument is vibrated or is caused to emit light, a person can therefore recognize the information. The light radiation device may include a light-emitting portion (lamp) provided on a front side of the external surface of the vehicle body, or may include a light-emitting portion provided on a rear side of the external surface of the vehicle body, or may include a room lamp provided on an internal surface of the vehicle body (in a vehicle compartment).

Examples of the front-side light-emitting portion include a headlamp, a clearance lamp, a fog lamp, a turn signal lamp, etc. Examples of the rear-side light-emitting portion include a stop/tail lamp, a rear turn signal lamp, a backup lamp, a license plate lamp, a high-mount stop lamp, etc. Light from a room lamp is recognizable from the outside through a window. Furthermore, the light radiation device may include a light-emitting portion provided on a wheel, a light-emitting portion provided near a wheel so as to illuminate the wheel, etc. The light radiation device includes at least one light-emitting portion. If the number of light-emitting portions included in the device is one, it is possible to report whether the state of air pressure has reached a set state by changing the state of light radiation between an on-state (radiating state) and an off-state (non-radiating state).

If the light-emitting portion is changed in the on/off switching pattern, light intensity, light color, etc., or at least two of these factors, different states of light radiation can be achieved, and therefore plural states of air pressure can be discriminatory reported. If the states of air pressure and the states of light radiation are associated in correspondence beforehand, a person outside the vehicle can recognize a state of air pressure corresponding to the state of light radiation. If the light radiation device includes a plurality of light-emitting portions, a plurality of states of air pressure can be discriminatory reported by, for example, changing turned-on light-emitting portions. The same applies to the sound generating device. That is, if at least two of the factors that include the switching of sound between an on-state (sounding state) and an off-state (silent state), the switching pattern, the pitch of sound (frequency), the volume of sound, etc., are changed, a person outside the vehicle can auditorily recognize plural states of air pressure discriminatory. The sound generating device may include a horn or the like, or may include an audio appliance, or may include the speech generation device of a navigation system. If an audio appliance or the speech generation device of a navigation system is included in the sound generating device, it is preferable that a loudspeaker be provided outside the vehicle, or that the volume of sound output be increased. Therefore, report outside the vehicle becomes possible.

The sound generating device may include a plurality of speakers. The reporting portion of the light radiation device, the sound generating device or the like may be an vehicle-mounted reporting portion (electrical equipment) provided in the vehicle beforehand, or an reporting portion provided in the vehicle specifically for reporting the state of air pressure. Although the vehicle-mounted reporting portion is provided for reporting the state of run of the vehicle and the like to the outside, the portion can be used as an reporting portion for reporting the state of air pressure. The portable instrument operates in accordance with the report information. The portable instrument itself is vibrated, or the state of the light-emitting portion of the portable instrument is changed, or sound is generated from the portable instrument. A person carrying such a portable instrument can recognize the state of air pressure by changes in the state of the portable instrument. The portable instrument may be a device equipped with a vehicle key function, or may be a cellular phone. It is often the case that an operating person has a portable instrument.

In the above-described aspect, the reporting device may include a movable reporting device that has a movable member that is visually recognizable from outside the vehicle, a driving portion that operates the movable member, and a driving control portion that controls the driving portion.

If motion of the movable member is recognizable from outside the vehicle, the state of air pressure can therefore be recognized by a person outside the vehicle. Different states of air pressure can be discriminatory reported by changing the state of motion of the movable member, for example, the speed of motion, the range of motion (distance, turning angle), the time of motion, etc. Examples of the movable member available include a window wiper, a window, a side mirror, etc. that exist in a vehicle beforehand.

In the above-described aspect, the reporting device may include a vehicle-mounted device that is provided in the vehicle and is operated in accordance with a driver's operation of an operating member, and an air pressure state-corresponding vehicle-mounted device control portion that generates the report information and operates the vehicle-mounted device in accordance with the report information generated.

If a vehicle-mounted device existing in the vehicle is utilized, the need to provide a dedicated reporting portion for reporting the state of air pressure disappears, and the cost increase can be curbed. A vehicle-mounted device, existing in the vehicle, is operated in accordance with a driver's operation of an operating member. A driver operates an operating member in many cases, for example, a case where the driver intends to report the state of operation to the outside, a case where the driver intends to improve the situation of operation, etc. The vehicle-mounted device is normally operated by electric signals. During a normal travel, the vehicle-mounted device is operated by the driver's operation of an operating member. For example, during supply of air pressure or the like, the vehicle-mounted device can be operated in accordance with the report information. The vehicle-mounted device may include, for example, a headlamp, a turn signal lamp, a horn, a window wiper, etc.

In the above-described aspect, the reporting device may include an air pressure supply state detection device that detects whether air pressure is being supplied to the tire.

Air is supplied to a tire, for example, through an operating person's operation of an air pressure supply device, or through operation of an automatic air pressure supply device provided in the vehicle. In any case, a state where air is being supplied to the tire is detected by the air pressure supply state detection device. The air pressure supply state detection device may detect whether air pressure is being supplied on the basis of the state of change in the tire air pressure or the like, or the state of operation of the automatic air pressure supply device, and may also accomplish the detection on the basis of the on/off state of a supply instruction switch provided so as to be operated by a driver for the operation of supplying air pressure.

In the above-described aspect, the air pressure supply state detection device may include an increase gradient-corresponding air pressure supply state detecting portion that determines that air pressure is being supplied if a gradient of increase in the air pressure is greater than a set gradient.

The air pressure supply state detection device includes an air pressure value detecting portion that detects a value of tire air pressure. It may be determined that air pressure is being supplied if the gradient of increase in the value of air pressure detected by the air pressure value detecting portion is greater than a set gradient (which may be termed air pressure supplying operation detection-purpose set gradient). In a case where air pressure is supplied by an automatic air pressure supply device during a run of the vehicle, the air pressure increases due to a rise in tire temperature. Therefore, in such a case, it is preferable to take the effect of temperature rise on air pressure increase into account in determining a set gradient.

In the above-described aspect, the air pressure supply state detection device may include a during-stop air pressure supply state detecting portion that determines that air pressure is being supplied if a gradient of increase in the air pressure is greater than a set gradient in a case where a rotation speed of the wheel that includes the tire is at most a set speed.

It may be determined that air pressure is being supplied if the wheel rotation speed is less than or equal to a set speed so that the vehicle can be considered to be in a stopped state and the gradient of increase in the air pressure is greater than the air pressure supplying operation detection-purpose set value.

In the above-described aspect, the reporting device reports the report information while it is detected by the air pressure supply state detection device that air pressure is being supplied. While air pressure is being supplied to a tire, the state of air pressure of the tire is reported. Therefore, the state of supply of air pressure to a tire can be recognized outside the vehicle.

In the above-described aspect, the reporting device may include an air pressure supply state reporting portion that generates air pressure supply state report information based on the state of air pressure detected by the air pressure state detection device and reports the air pressure supply state report information if it is detected by the air pressure supply state detection device that air pressure is being supplied.

The state of supply of air pressure can be detected on the basis of the state of air pressure detected by the air pressure state detection device. The air pressure supply state report information may be termed air pressure supplying operation state report information if the supply of air pressure is carried out by an operating person. The air pressure supply state report information may be information indicating that the supply of air pressure is completed (information indicating that the air pressure has reached a target value), or information indicating a time expected to elapse until the target value is reached. A time elapsing until the air pressure reaches the target value or the like can be predicted on the basis of the state of air pressure occurring at a present time point. If the air pressure supply state report information is reported in a case where air pressure is supplied by an operator operating the air pressure supply device, the operator does not need to look at a gauge of the air pressure supplying device, or is allowed to reduce the frequency of looking at the gauge. The cumbersomeness of the operation can be lightened. If air pressure is supplied by an automatic air pressure supply device, it is possible to instruct the automatic air pressure supply device to stop operating. Furthermore, it becomes possible to grasp the remaining time of operation of the automatic air pressure supply device or the like.

In the above-described aspect, the reporting device may include an air pressure state information generating portion that generates different kinds of pieces of air pressure state report information in accordance with different states of air pressure detected by the air pressure state detection device, and an reporting portion capable of discriminatory reporting the different kinds of pieces of air pressure report information generated by the air pressure state information generating portion.

If different kinds of pieces of air pressure supply report information can be generated and can be discriminatory reported, a person outside the vehicle can recognize and discriminate between different kinds of states of air pressure. The same applies to the air pressure supply state report information. That is, it is preferable that different kinds of pieces of air pressure supply state report information can be generated and can be discriminatory reported in accordance with the state of air pressure detected by the air pressure state detection device.

In the above-described aspect, at least one of the wheel and the vehicle body may be provided with a tire temperature-related information obtainment device that obtains tire temperature-related information, that is, information related to a temperature of the tire.

The tire temperature-related information may be information indicating the temperature of the tire itself, or information that allows estimation of the tire temperature. The tire temperature itself can be directly detected, for example, via a tire temperature sensor provided on the wheel. Examples of the information that allows estimation of the tire temperature include information indicating the state of run of the vehicle (including the state of rotation of a wheel), the external air temperature, the road surface temperature, combinations of at least two of these factors, etc. The external air temperature and the road surface temperature can be detected via an external air temperature sensor and a road surface temperature sensor, respectively. If these temperatures are high, the tire temperature becomes high. Therefore, the tire temperature can be estimated on the basis of these temperatures. Furthermore, it is also possible to estimate that the tire temperature is higher than or equal to a second set temperature if the external air temperature or the road surface temperature is higher than or equal to a first set temperature. This is effective to determine whether the tire temperature is higher than or equal to the second set temperature. Furthermore, as discussed below, it is possible to assume that the tire temperature is higher when the time of travel, as a state of run of the vehicle, is long than when the time of travel is short. Furthermore, the tire temperature may also be estimated on the basis of both the state of run and one of the external air temperature and the road surface temperature.

In the above-described aspect, the tire temperature-related information obtainment device may include a rotation state detection device that detects a state of rotation of the wheel, and the reporting device may include a rotation state-corresponding temperature estimating portion that estimates a temperature of the tire based on the state of rotation detected by the rotation state detection device.

The state of rotation of the wheel is detected by the rotation state detection device. The rotation state detection device may be, for example, a device that detects the time during which the rotation speed of the wheel is greater than or equal to a set speed, or a device that detects the time during which the rotation acceleration or deceleration is greater than or equal to a set value. For example, the tire temperature is higher if the time of rotation of the wheel is long than if it is short. Furthermore, the tire temperature is higher if the time during which the rotation acceleration or deceleration is greater than a set value than if the time is shorter than the set time. The state of rotation of the wheel may be detected during the period from the turning-on of the ignition switch until the present time point, or may be detected during the immediately preceding set time. In any case, the tire temperature can be estimated on the basis of the time during which the wheel is in a rotating state (time of travel), the time during which the acceleration/deceleration is greater than or equal to a set value (driving/braking time), etc. The state of rotation of the wheel can be detected on the basis of the state of run of the vehicle.

In the above-described aspect, the reporting device may include a standard state air pressure obtaining portion that obtains the air pressure of the tire in a standard state based on the tire temperature-related information obtained by the tire temperature-related information obtainment device and the state of air pressure detected by the air pressure state detection device.

In the above-described aspect, the reporting device may include a set pressure attainment information reporting portion that reports that the air pressure of the tire in the standard state obtained by the standard state air pressure obtaining portion is at least a set pressure if the air pressure of the tire in the standard state obtained by the standard state air pressure obtaining portion is at least the set pressure.

The set pressure during the supply of air pressure may be an appropriate value of air pressure, or a value obtained by subtracting a set value from the appropriate value, or a value obtained by adding a set value to the appropriate value, or a target value set by a driver, etc. The appropriate value of the tire air pressure is a value predetermined for the vehicle, and is determined by a vehicle maker in many cases. A plurality of appropriate values may be determined in some cases. In many cases, the appropriate value is expressed as a value of air pressure in a standard state. Since it is often the case that the appropriate value is used as a target value in supplying air pressure, the appropriate value may be termed target value for the operation of supplying air pressure.

It is possible to provide only one set pressure or a plurality of set pressures. If a plurality of set pressures are provided, report is performed every time any one of the set pressures is reached. For example, it is possible to make arrangement such that the state of air pressure is reported in a plurality of stages before the air pressure reaches the target value. If the set pressure is a value that is greater than the target value or an upper limit value of the appropriate value, it becomes possible to avoid excessive supply of air pressure. Since the set pressure is expressed as a value of air pressure in the standard state in many cases as mentioned above, it is preferable that the air pressure to be compared with the set pressure be also adjusted to a value based on the standard state. The standard state may be, for example, a state where the temperature equals a standard temperature, a state where the load equals a set load, a state where the temperature and the load equal their respective standard values.

In the above-described aspect, the standard state air pressure obtaining portion may include a high temperature-time obtaining portion that obtains the standard state air pressure if the tire temperature indicated by the tire temperature-related information obtained by the tire temperature-related information obtainment device is at least a set temperature.

The set temperature may be a value that is at least a set value higher than the standard temperature. If the tire temperature is lower than the set temperature, the need to obtain the standard state air pressure (standard-temperature air pressure) is low. However, if the tire temperature is higher than or equal to the set temperature, it is preferable to obtain the standard-temperature air pressure. That is, if the tire temperature is lower than the set temperature, it can be assumed that the detected air pressure, that is, the air pressure detected by the air pressure state detection device, is equal to the standard-temperature air pressure. The same applies to the load. That is, if the load is greater than a set load that is at least a set value greater than the standard load, it is preferable to obtain an air pressure that would occur if the standard load is applied.

In the above-described aspect, the reporting device may include an inside reporting portion that reports the report information to inside the vehicle during a normal condition, and an outside reporting portion that reports the report information to outside the vehicle if it is detected by the air pressure supply state detection device that air pressure is being supplied. During a normal condition, the state of air pressure is reported to inside the vehicle. If air pressure is being supplied, the state of air pressure is reported to outside the vehicle. In this sense, the inside reporting portion may be termed normal-time reporting portion, and the outside reporting portion may be termed air pressure supply-time reporting portion.

In the above-described aspect, if the standard state air pressure reaches a target value, the outside reporting portion may report so, and if the standard state air pressure is lower than a reference value, the inside reporting portion may report so. It is preferable that the outside reporting portion report that the air pressure has reached a target value and the inside reporting portion report that the air pressure has become lower than an air pressure (reference value) at which air pressure should preferably be supplied. The reference value may be a value such that the run of the vehicle is expected to become difficult in the near future, or a value such that the air pressure is considered abnormal. The reference value is lower than the target value. As for the inside reporting portion, it is preferable that the reference value be set at a relatively high value after the supply of air pressure. For example, until the elapse of a set time following the end of supply of air pressure, the reference value is set at a higher value than after the elapse of the set time. In this case, it is possible to determine the reference value in accordance with the time of travel or the travel distance instead of the set time.

In the above-described aspect, the reporting device may include an abnormality reporting portion that reports that a gradient of increase in the air pressure is at most an abnormality detection-purpose set gradient if the gradient of increase in the air pressure is at most the abnormality detection-purpose set gradient in a case where it is detected by the air pressure supply state detection device that air pressure is being supplied. If the gradient of increase in the air pressure has become equal to or less than the abnormality detection-purpose set gradient after the gradient of increase has been detected to be greater than the aforementioned air pressure supply detection-purpose set gradient (set gradient), it is sometimes the case that there is abnormality in the automatic air pressure supply device or the air pressure supply device operated by an operating person or there is abnormality in the tire. That is, there are cases where while the tire air pressure is low, air pressure can be supplied with a gradient of increase that is greater than the air pressure supply detection-purpose set gradient, and where when the tire air pressure becomes high, high-pressure air cannot be supplied and the gradient of increase becomes less than or equal to the abnormality detection-purpose set gradient. Incidentally, the air pressure supply detection-purpose set gradient is greater than the abnormality detection-purpose set gradient.

In the above-described aspect, the wheel may be provided with a wheel information transmitting portion that transmits wheel information that includes the state of air pressure detected by the air pressure state detection device, and the vehicle body may be provided with a receiving portion that receives the wheel information, and the reporting device may include a received information-based air pressure state obtaining portion that obtains the state of air pressure based on the wheel information received by the receiving portion. In this air pressure state reporting apparatus, the wheel-side device and the vehicle body-side device exchange information with each other via communications. That is, the state of air pressure detected by the wheel-side device is transmitted, and the state of air pressure is received by the vehicle body-side device. On the basis of the received information, the state of air pressure is obtained.

In the above-described aspect, the reporting device may be provided on the wheel.

In the above-described aspect, the reporting device may include a puncture repair state detection device that detects whether the tire is under a puncture repair. This air pressure state reporting apparatus may be employed, for example, during puncture repair instead of the supply of air pressure.

In the above-described aspect, the air pressure state reporting apparatus may include an air pressure state detection device that is provided on a wheel and that detects a state of air pressure of a tire of the wheel, an air pressure supply state detection device that detects whether air pressure is being supplied to the tire, and an reporting device that generates air pressure supply state report information based on the state of air pressure detected by the air pressure state detection device and reports the air pressure supply state report information generated, if it is detected by the air pressure supply state detection device that air pressure is being supplied. In this air pressure state reporting apparatus, the state of air pressure is reported. The air pressure supply state may be termed state of air pressure supplying operation performed by an operating person, or may be termed state of operation of the automatic air pressure supply device.

In the above-described aspect, the air pressure state reporting apparatus may include an air pressure detection device that is provided on a wheel and that detects a value of air pressure of a tire of the wheel, an air pressure supply state detection device that detects whether air pressure is being supplied to the tire, an abnormality detection device that determines that there is an abnormality if a state where a gradient of change in the value of air pressure is at most a set gradient continues for at least a set time provided that it is detected by the air pressure supply state detection device that air pressure is being supplied, and an abnormality reporting device that reports that there is an abnormality if the abnormality detection device detects so. The set gradient, that is, a threshold value for detection as to whether there is abnormality, may be, for example, the aforementioned abnormality detection-purpose set gradient.

In the above-described aspect, the air pressure state reporting apparatus may include an air pressure detection device that is provided on a wheel and that detects a value of air pressure of a tire of the wheel, and a standard state air pressure value obtaining portion that obtains a standard state air pressure value based on a detected air pressure value detected by the air pressure detection device and at least one of a load applied to the wheel and a temperature of the tire. In this air pressure state reporting apparatus, the standard state air pressure value is obtained on the basis of the detected air pressure and the load, or the standard air pressure value is obtained on the basis of the detected air pressure, the load and the tire temperature.

In accordance with a second aspect of the invention, an air pressure reporting method includes a first step of detecting a state of air pressure of a tire of a wheel, and a second step of generating report information indicative of an air pressure state based on the state of air pressure detected, and reporting the report information generated to outside a vehicle.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a diagram illustrating an overall construction of a wheel state obtainment device that includes an air pressure state reporting device in accordance with an embodiment of the invention;

FIG. 2 is a diagram conceptually illustrating a wheel-side device and a vehicle body-side device of the wheel state obtainment device;

FIG. 3 is a flowchart illustrating a transmission control program stored in an information processing device of the wheel-side device;

FIG. 4 is a flowchart illustrating a target value determining program stored in the vehicle body-side device;

FIG. 5 is a flowchart illustrating an report control program stored in the vehicle body-side device; and

FIG. 6 is a flowchart illustrating a reference value determining program stored in the vehicle body-side device of a wheel state obtainment device that includes an air pressure state reporting device in accordance with another embodiment of the invention.

### DETAILED DESCRIPTION OF PREFERRED EMBODIMENTS

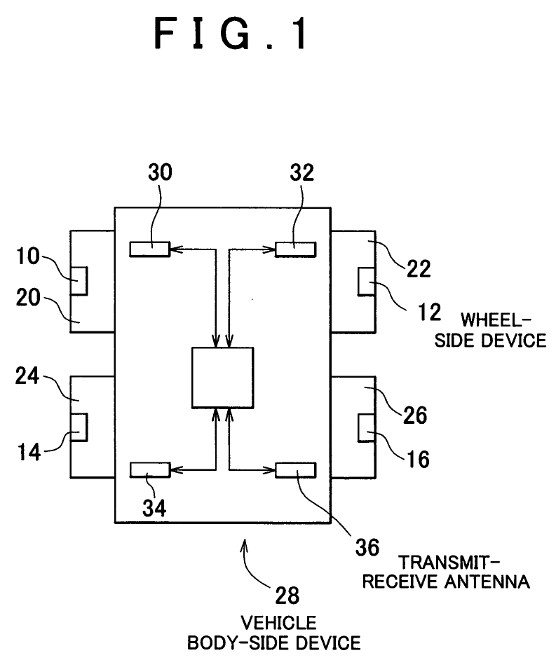

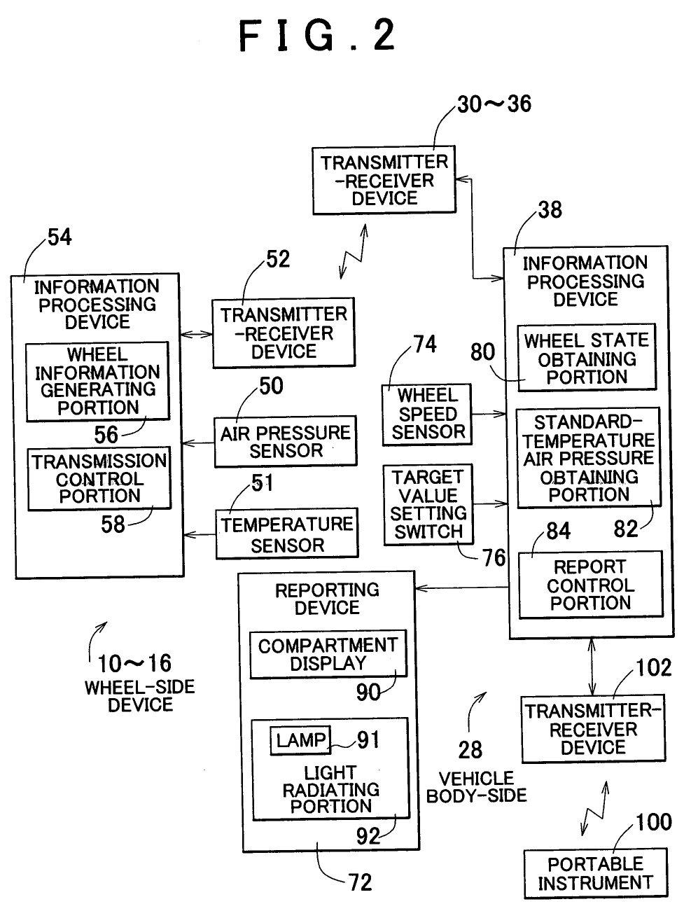

Hereinafter, an air pressure reporting apparatus of an embodiment of the invention will be described in detail with reference to the accompanying drawings. In FIG. 1, wheel-side devices 10-16 are sensor-side devices provided respectively on front and rear left and right-side wheels 20-26. A vehicle body-side device 28 includes transmitter-receiver devices 30-36 provided on portions of a vehicle body which are adjacent to the wheels 20-26, respectively, and an information processor device 38. As shown in FIG. 2, each of the wheel-side devices 10-16 includes an air pressure sensor 50 for detecting the air pressure in the tire of a corresponding one of the wheels, a temperature sensor 51 for detecting the temperature of the tire (the temperature of air inside the tire), a transmitter-receiver device 52 capable of transmitting and receiving information, an information processor device 54 formed mainly by a computer, etc. The transmitter-receiver device 52 includes a transmit-receive antenna, a receiver circuit, a transmitter circuit, etc. The information processor device 54 includes a wheel information generating portion 56 for generating wheel information that includes the value of air pressure detected by the air pressure sensor 50, the temperature detected by the temperature sensor 51, as well as a transmission control portion 58 for controlling the state of transmission of wheel information, and the like.

The vehicle body-side device 28 includes the aforementioned transmitter-receiver devices 30-36, the information processor device 38 having a computer as a main component, an reporting device 72, wheel speed sensors 74, a target value setting switch 76, etc. The information processor device 38 includes a wheel state obtaining portion 80 for obtaining the state of the wheel, such as the air pressure, the temperature, etc., on the basis of the wheel information received by the transmitter-receiver devices 30-36, a standard-temperature air pressure obtaining portion 82 for obtaining the air pressure at a standard temperature on the basis of the air pressure and the temperature obtained by the wheel state obtaining portion 80 (through adjustment based on the temperature), an report control portion 84 for controlling the reporting device 72, etc. The transmitter-receiver devices 30-36 are disposed on portions of the vehicle body adjacent to the wheels 20-26, respectively, and each of the devices includes a transmit-receive antenna, a receiver circuit, a transmitter circuit, etc.

The reporting device 72 includes a display 90 provided in an instrument panel in a vehicle compartment, and a light radiating portion 92 that includes a lamp 91 for radiating light to outside the vehicle. The reporting device 72 is actuated on the basis of a command from the report control portion 84. The display 90 generates an image corresponding to a command (information) from the report control portion 84, and displays it on the screen. The light radiating portion 92, in accordance with the command from the report control portion 84 (which may be, for example, information indicating an on/off change pattern), controls the state of light radiation and controls the state of flicker (on/off change pattern) of light radiated from the lamp 91. By the state of light flicker of the lamp 91, the state of tire air pressure can be recognized by a person outside the vehicle. The lamp 91 in this embodiment is provided on an outside surface of the vehicle body beforehand, and may be, for example, a front-side lamp or a rear-side lamp. Examples of the front-side lamp in this case include a headlamp, a clearance lamp, a fog lamp, a turn signal lamp, etc. Examples of the rear-side lamp in this case include a stop-and-tail lamp, a backup lamp, a rear turn lamp, a license plate lamp, a high-mount stop lamp, etc.

The vehicle speed sensors 74 are provided for the individual wheels for detecting the rotation speeds thereof. Differentiation of the rotation speed provides a rotation acceleration or a rotation deceleration. The target value setting switch 76 is operated by a driver so as to set a target value of the air pressure during the supply of air pressure.

The vehicle body-side device 28 further includes a transmitter-receiver device 102 for a portable instrument 100. The portable instrument 100 is supplied with a command from the vehicle body-side device 28 via the transmitter-receiver device 102, and is actuated in accordance with the command. The portable instrument 100 may be designed so as to vibrate, emit light from a light-emitting portion, or generate a buzzer sound or the like, on the basis of the command from the report control portion 84 of the vehicle body-side device 28. The portable instrument 100 may also be equipped with a vehicle key function, and may further be equipped with a telephone function.

Each wheel-side device 10-16 generates wheel information that includes the tire air pressure value detected by the air pressure sensor 50 (hereinafter, referred to as “detected air pressure value”), and the tire temperature detected by the temperature sensor 51, and transmits the information at every predetermined set time. On the other hand, the vehicle body-side device 28 obtains the detected air pressure and the temperature based on the wheel information received, and determines a standard-temperature air pressure based on the detected air pressure value and the temperature. The air pressure is higher when the tire temperature is high than when the tire temperature is low. Therefore, an air pressure value adjusted with reference to the predetermined standard temperature is computed. If the wheel information includes the temperature ts and the air pressure Ps, the air pressure P at the standard temperature T0 can be determined as in:
P=(273+T0)·Ps/(273+ts)
The standard temperature T0 may be, for example, 20° C.

The vehicle body-side device 28 determines whether air pressure is being supplied to a tire. If air pressure is being supplied to a tire, the standard-temperature air pressure is determined. If the standard-temperature air pressure is greater than or equal to a target value, this fact is indicated to the driver and the like. In this embodiment, it is determined that air pressure is being supplied to a tire in a case where the wheel rotation speed detected by a wheel speed sensor 74 is less than or equal to a set speed which allows an assumption that the vehicle is at a stop and where the gradient of increase in the detected air pressure or the standard-temperature air pressure is greater than or equal to a set gradient. For example, the set gradient may be 10 kPa per minute. The set gradient may be termed air pressure supply detection-purpose set gradient. The target value of air pressure during supply thereof, in this embodiment, may be an actual air pressure that occurs at a time point when the target value setting switch 76 is operated by an operating person. It is verified that the actual air pressure at this time point is adjacent to a value predetermined to be an appropriate value by a maker or the like.

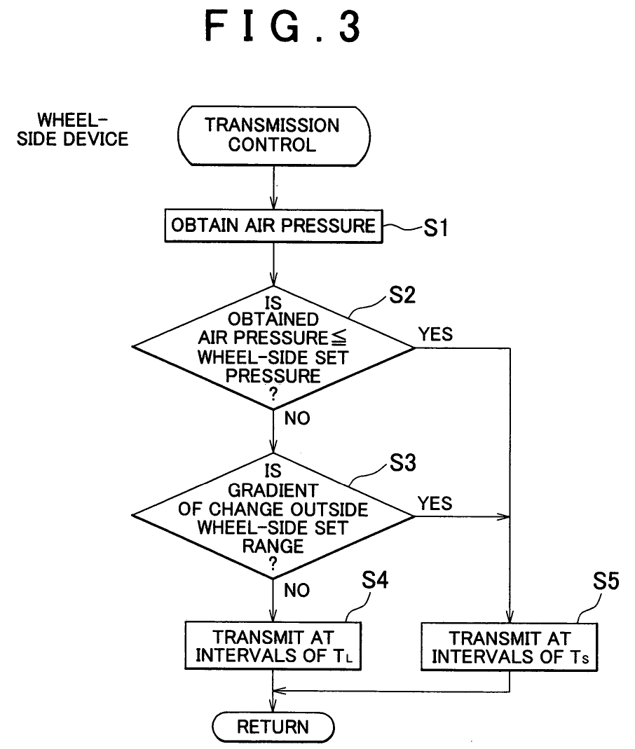

Each wheel-side device executes a transmission control program illustrated by the flowchart of FIG. 3. At step 1 (which will hereinafter be simply referred to as “S1”. The other steps will be referred to in similar manners), the value of air pressure detected by the air pressure sensor 50 is read. Subsequently at S2, it is determined whether the air pressure value less than or equal to a predetermined wheel-side set pressure of a concerned one of the wheel-side devices 10 to 16. At S3, it is determined whether the gradient of change (gradient of increase or gradient of decrease) is outside a wheel-side set range. If the air pressure value is higher than the wheel-side set pressure and the gradient of change in the air pressure value is within the set range, wheel information that includes the air pressure value and the temperature is generated and transmitted at intervals of a time TL. Conversely, if the air pressure value is less than or equal to the wheel-side set pressure, or if the gradient of change in the air pressure value is not within the wheel-side set range, wheel information is generated and transmitted at intervals of a time TS.

For example, the wheel-side set pressure regarding the air pressure value, and the wheel-side set range regarding the gradient of change may be set at magnitudes that indicate that the air pressure is abnormal so that abnormality should be reported to the vehicle body side. The time TS is shorter than the time TL. That is, if the air pressure is abnormal, wheel information is generated and transmitted at shorter time intervals. If the air pressure drops due to a tire puncture or the like, wheel information is generated and transmitted at short time intervals. During supply of air pressure, the gradient of increase in the air pressure is normally outside the set range, and therefore wheel information is transmitted at short time intervals. In this embodiment, the air pressure value and the temperature are detected by the air pressure sensor 50 and the temperature sensor 51 at time intervals that are shorter than or equal to the time TS. The state of transmission may be determined on the basis of a command from the vehicle body-side device 28. For example, it is possible to shorten the transmission intervals if a piece of information requesting the air pressure value at high frequency is supplied from the vehicle body-side device 28.

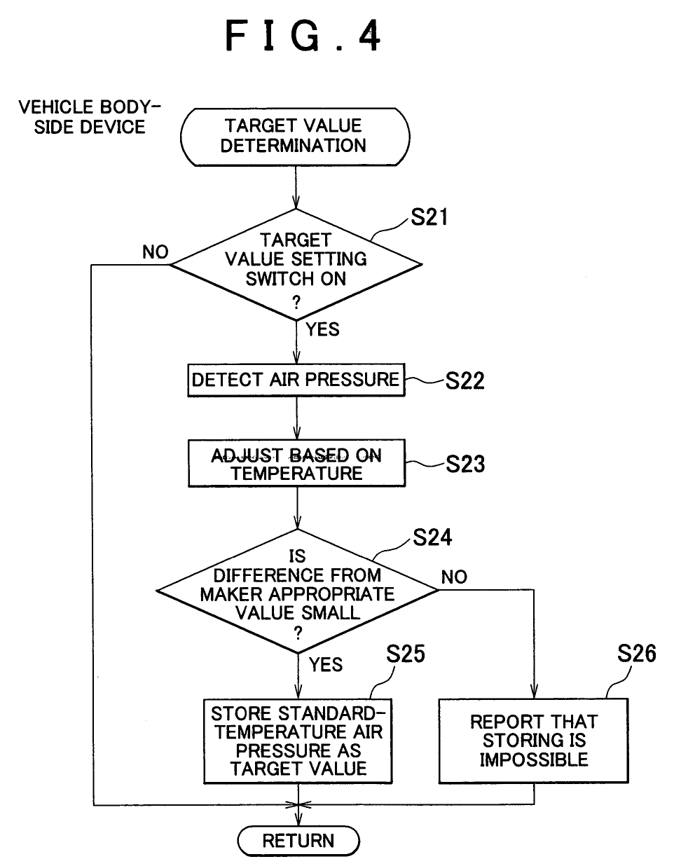

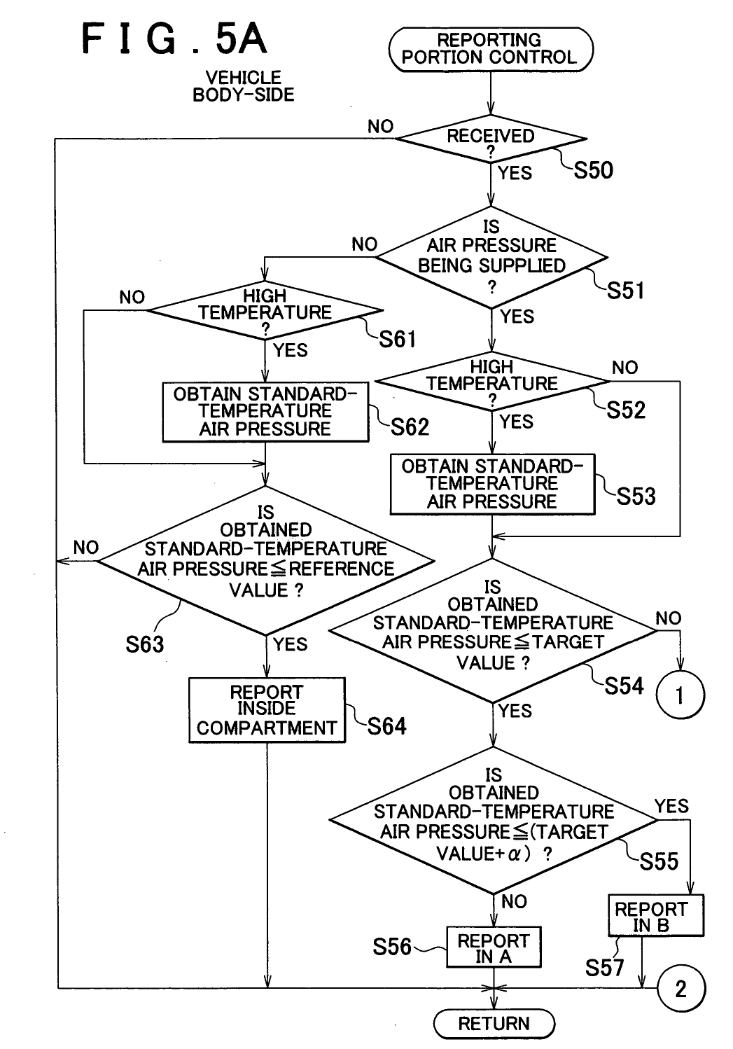

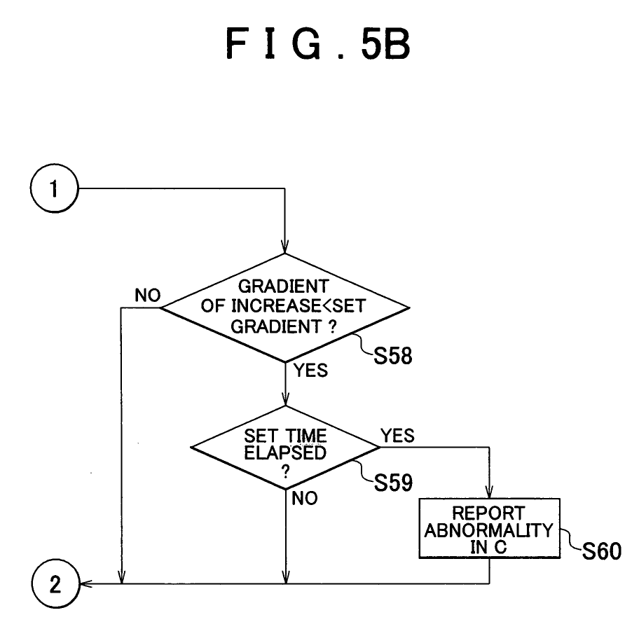

The vehicle body-side device 28 executes a target value determining program illustrated by the flowchart of FIG. 4, and executes an reporting portion control program illustrated by the flowchart of FIG. 5. At S21, it is determined that the target value setting switch 76 has been operated. If the target value setting switch 76 is not operated, the process of S22 and the following steps will not be executed. If the target value setting switch 76 has been operated, the air pressure value and the temperature are obtained from wheel information at S22, and a standard-temperature air pressure is computed at S23. Subsequently at S24, it is determined whether the absolute value of a difference between the standard-temperature air pressure and the aforementioned predetermined appropriate value (e.g., which may be a value determined beforehand by a maker or the like) is less than or equal to a set value. If the absolute value of the difference is less than or equal to the set value, the value is adopted at S25 as a target value during supply of air pressure. Conversely, if the absolute value of the difference exceeds the set value, it is reported at S26 that the value is inappropriate as a target value. For example, the information that the absolute value is inappropriate may be indicated on the display 90 in the vehicle compartment. The appropriate value may be about 200 kPa, and the set value of threshold for the absolute value of the difference may be, for example, about 50 kPa in magnitude. Incidentally, the actual tire air pressure value in the case where the target value setting switch 76 has been operated may be a mean value of the air pressure values of the plural wheels 20 to 26, or may be an air pressure value obtained on the basis of the latest wheel information received. In addition, as the target value, the capability thereof to be set by a vehicle driver is not essential. That is, the target value ay be an appropriate value or a value close to the appropriate value.

At S50 in the flowchart of FIG. 8, it is determined whether wheel information has been received. If wheel information has been received, it is determined at S51 whether air pressure is being supplied. Specifically, it is determined whether the vehicle is in a stopped state and the gradient of increase in the air pressure value is greater than or equal to a set gradient (a set gradient for detecting the supply of air pressure). If it is determined that air pressure is being supplied into a tire by an operating person, it is then determined at S52 whether the tire temperature is higher than or equal to a set temperature. The set temperature is higher than a standard temperature by at least a set value. If the tire temperature is higher than or equal to the set temperature, the need for adjusting the air pressure value with reference to temperature is considered high. If the tire temperature is higher than or equal to the set temperature, the standard-temperature air pressure is determined at S53 through computation as described above. Conversely, if the tire temperature is lower than the set temperature, the detected air pressure value is directly used. This is because the difference between the detected air pressure value and the standard-temperature air pressure value is considered small. Subsequently at S54, it is determined whether the standard-temperature air pressure or the detected air pressure value is higher than or equal to the target value. If the standard-temperature air pressure or the detected air pressure value is higher than or equal to the target value, it is then determined at S55 whether the standard-temperature air pressure or the detected air pressure value is higher than or equal to a value that is greater than target value by α(i.e., target value+α).

If the air pressure value is within the range of the target value to the target value+α, the lamp 91 is flickered in a pattern A at S56. If the air pressure value is greater than or equal to the target value+α, the lamp 91 is flickered in a pattern B at S57. If the air pressure value is lower than the target value, the lamp 91 remains in an off-state. The magnitude of (target value+α) may be, for example, about 30 kPa. Although the air pressure may be slightly higher than the target value, excessively high air pressure is not desirable. If the target value+α is reached, this fact is reported. In this sense, the target value+α may be termed target upper limit value, or may be termed excessive air pressure supply preventing target value. Furthermore, the lamp 91 may be flickered in patterns that are different between a case where the air pressure is higher than or equal to the target value and a case where the air pressure is higher than or equal to the target value+α. Therefore, the operating person can recognize and discriminate between the air pressure reaching the target value and the air pressure reaching the target value+α.

In contrast, if the air pressure is lower than the target value, it is determined at S58 whether the gradient of increase in the air pressure is less than an abnormality detection-purpose set gradient. The abnormality detection-purpose set gradient may be a very small value having such a magnitude that the tire or the air pressure supplying device can be considered abnormal. If the gradient of increase is less than the set gradient, it is determined at S59 whether the present state has continued for at least a set time. If the state where the gradient of increase is less than the set gradient has continued for at least the set time, occurrence of abnormality is reported. In that case, the lamp 91 is flickered in a pattern C. Therefore, an operating person will understand that the air pressure supplying device or the tire is abnormal. While the air pressure of a tire is low, air pressure can be supplied into the tire even if the air pressure supplying device is abnormal. In such a case, however, as the tire air pressure increases, it sometimes becomes impossible to supply high-pressure air pressure into the tire.

If air pressure is not being supplied, it is determined at S61 whether the tire has high temperature. If the tire has high temperature, the standard-temperature air pressure is computed at S62. Subsequently at S63, it is determined whether the standard-temperature air pressure or the detected air pressure value is lower than a vehicle body-side reference value. The vehicle body-side reference value in this case may be set at such a magnitude that the supply of air pressure can be considered preferable, or such a magnitude that the air pressure value can be considered abnormal. The vehicle body-side reference value may be equal in magnitude to the wheel-side reference value. If the air pressure value is less than or equal to the vehicle body-side reference value, this fact is reported on the display 90 in the vehicle compartment. As described above, if the tire air pressure is low or if the gradient of change in the air pressure is great, wheel information is transmitted at short time intervals. Therefore, the vehicle body-side device 28 can frequently obtain wheel information, that is, can minutely detect the state of change in the air pressure.

As described above, in this embodiment, the lamp 91 that radiates light to outside the vehicle is flickered during supply of air pressure, so that an operating person outside the vehicle can learn about the state of the operation of supplying air pressure. Therefore, the operating person does not need to check a gauge of the air pressure supplying device, or is allowed to reduce the frequency of checking the gauge. The cumbersomeness of the air pressure supplying operation can be lightened. In some cases, an operating person injects a tire repair material into a tire, in addition to the supply of air pressure.

In this embodiment, the transmitter-receiver devices 30-36, portions of the information processor device 38 that store S50 and S51 shown in the flowchart of FIG. 5, portions thereof that execute S50 and S51, etc., may be regarded as corresponding to “an air pressure supply state detecting device”. Portions of the information processor device 38 that store S53 and S62, portions thereof that execute S53 and S62, etc., may be regarded as corresponding to “a standard-temperature air pressure obtaining portion”. The light radiating portion 92 and the report control portion 84 may be regarded as corresponding to “an reporting device”. The light radiating portion 92 may be provided in the vehicle beforehand, and may be a vehicle-mounted reporting portion as a vehicle-mounted device.

Although in the foregoing embodiment, the lamp 91 is employed as an reporting portion, a horn and the like may also be used as an reporting portion. With the sound generated from the horn, an operating person becomes aware that the air pressure has reached the target value. Furthermore, the state of air pressure may also be reported via the portable instrument 100. In that case, the portable instrument 100 is vibrated, or a buzzer sound or the like is generated from the portable instrument 100, or the light-emitting portion is flickered, etc. In this embodiment, different kinds of states of air pressure can be discriminatory reported. Although in the embodiment, the transmitter-receiver device 102 for the portable instrument is provided separately from the transmitter-receiver devices 30-36 provided for the wheel-side device, the transmitter-receiver devices 30-36 and the transmitter-receiver device 102 may be combined as common devices.

Furthermore, the state of air pressure may be reported by moving a movable member, such as a windshield wiper, a window, a side mirror, etc. In this embodiment, if the states of rotation (rotation angle, a rotating speed, a rotation frequency, number of rotations, a rotation time, etc.) are changed, it becomes possible to report the plural states of air pressure discriminatory. It is also possible to provide an reporting portion dedicated for reporting the state of tire air pressure. It is also possible to provide a lamp at such a position that light from the lamp can illuminate the wheels 20 to 26 of the vehicle body, or provide a light-emitting portion on each tire wheel.

Furthermore, the tire temperature may be obtained by the vehicle body-side device 28. For example, a tire temperature can be estimated on the basis of the travel distance or the travel time during a period from the turning-on of the ignition switch until the supply of air pressure following stop of the vehicle, the elapsed time after the stop, etc. It can be assumed that the temperature is higher if the travel distance or the travel time is longer and the temperature decreases as the elapse time following stop of the vehicle increases. In this case, it is not essential to provide the temperature sensor 51 on each wheel-side device 10-16. The estimated temperature is used commonly for the wheels.

It is also possible to assume that the outside air temperature equals the tire temperature. The tire temperature is normally higher when the outside air temperature is high than when the outside air temperature is low. The tire temperature may also be estimated on the basis of the outside air temperature combined with the state of run, and the like. An arrangement may be made beforehand such that a supply instruction switch will be operated prior to the operation of supplying air pressure into a tire. In this case, if the supply instruction switch is operated, it is determined that air pressure is being supplied. It is also possible to adopt a construction in which a command to transmit wheel information at short intervals is transmitted from the vehicle body-side device 28 to the wheel-side devices 10-16 in accordance with the operation of the supply instruction switch. Furthermore, although in the foregoing embodiment, the standard-temperature air pressure is compared with the target value, it is also possible that the air pressure occurring when the temperature and the load have standard values (standard temperature/load air pressure) be compared with a target value. As for load, each wheel-side device 10-16 may be provided with an acting force sensor so that wheel information, including air pressure, temperature and acting force, is supplied to the vehicle body-side device 28. Furthermore, the vehicle body-side device 28 may be constructed so as to detect a load applied to each wheel on the basis of the posture of the vehicle.

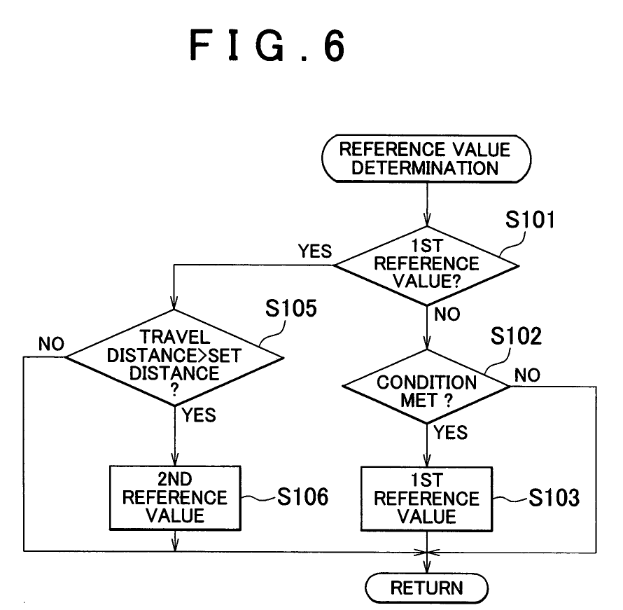

Furthermore, in the foregoing embodiment, if the tire temperature is higher than or equal to the set temperature, the standard-temperature air pressure is computed. However, it is also possible that the standard-temperature air pressure be computed regardless of whether the tire temperature is higher or lower than the set temperature. Furthermore, the reference value in a normal condition may be set at a value that is higher just after supply of air pressure than during other states, instead of being always set at a fixed value. In the foregoing embodiment, a reference value determining program illustrated in the flowchart of FIG. 6 is executed at every predetermined set time. It is to be noted herein that a first reference value is greater than a second reference value. At S101, it is determined whether the presently set reference value is the first reference value. If the presently set reference value is not the first reference value, it is then determined at S102 whether an air pressure supply ending condition is met. If the air pressure supply ending condition is met, the reference value is set at the first reference value at S103. If the air pressure supply ending condition is not met or until the condition is met, the second reference value remains as the presently set reference value. The air pressure supply ending condition is a condition that a state where the gradient of increase in the air pressure is higher than or equal to an air pressure supply detection-purpose set gradient be detected and that the air pressure be greater than or equal to the target value.

In contrast, if it is determined at S101 that the presently set reference value is the first reference value, it is then determined at S105 whether the travel distance has exceeded a set distance following the setting of the first reference value, that is, following the end of air pressure supply. If the travel distance has become equal to or greater than the set distance following the end of the air pressure supply, the reference value is set back to the second reference value. Conversely, if the travel distance is less than or equal to the set distance, the first reference value remains as the set reference value.

Furthermore, it is not essential that the vehicle body-side device include a plurality of transmitter-receiver devices provided for the wheels. That is, the vehicle body-side device may include only one transmitter-receiver device. The invention is applicable not only to a case where the air pressure supplying operation is performed by an operator operating the air pressure supplying device, but also to a case where a vehicle is equipped with an automatic air pressure supplying device and air pressure is automatically supplied by the automatic air pressure supplying device. In this case, if the state of air pressure is reported to the outside, the state of supply of air pressure of a tire of a vehicle can be reported to a vehicle driver or the like in the case where the driver is outside the vehicle, or the like. Furthermore, the reporting device may also be provided on a wheel-side device. The invention may be carried out with various modifications and improvements based on the knowledge of those having ordinary skill in the art in addition to the forms described above in the Summary of the Invention.

1. An air pressure state reporting apparatus comprising:
an air pressure state detection device that is provided on a wheel and that detects a state of air pressure of a tire of the wheel; and
a reporting device that generates report information indicative of an air pressure state based on the state of air pressure detected by the air pressure state detection device, and that reports the report information generated to outside a vehicle.

2. The air pressure state reporting apparatus according to claim 1,
wherein the reporting device includes an report information generating portion that generates the report information, and an reporting portion that is operated in accordance with the report information generated by the report information generating portion, and
wherein the reporting portion includes at least one of a light radiation device that radiates light to outside the vehicle, a sound generating device that generates a sound to outside the vehicle, and a portable instrument that is separate from the vehicle.

3. The air pressure state reporting apparatus according to claim 1, wherein the reporting device includes an air pressure state information generating portion that generates different kinds of pieces of air pressure state report information in accordance with different states of air pressure detected by the air pressure state detection device, and an reporting portion capable of discriminatory reporting the different kinds of pieces of air pressure report information generated by the air pressure state information generating portion.

4. The air pressure state reporting apparatus according to claim 1, wherein the reporting device includes a vehicle-mounted device that is provided in the vehicle and is operated in accordance with operation of an operating member by a driver, and an air pressure state-corresponding vehicle-mounted device control portion that generates the report information and operates the vehicle-mounted device in accordance with the report information generated.

5. The air pressure state reporting apparatus according to claim 1, wherein the reporting device includes a movable reporting device that has a movable member that is visually recognizable from outside the vehicle, a driving portion that operates the movable member, and a driving control portion that controls the driving portion.

6. The air pressure state reporting apparatus according to claim 1,
wherein the reporting device includes an air pressure supply state detection device that detects whether air pressure is being supplied to the tire, and
wherein the reporting device reports the report information while it is detected by the air pressure supply state detection device that air pressure is being supplied.

7. The air pressure state reporting apparatus according to claim 6, wherein the air pressure supply state detection device includes an increase gradient-corresponding air pressure supply state detecting portion that determines that air pressure is being supplied if a gradient of increase in the air pressure is greater than a set gradient.

8. The air pressure state reporting apparatus according to claim 6, wherein the reporting device includes an abnormality reporting portion that reports that a gradient of increase in the air pressure is at most an abnormality detection-purpose set gradient if the gradient of increase in the air pressure is at most the abnormality detection-purpose set gradient in a case where it is detected by the air pressure supply state detection device that air pressure is being supplied.

9. The air pressure state reporting apparatus according to claim 6, wherein the air pressure supply state detection device includes a during-stop air pressure supply state detecting portion that determines that air pressure is being supplied if a gradient of increase in the air pressure is greater than a set gradient in a case where a rotation speed of the wheel that includes the tire is at most a set speed.

10. The air pressure state reporting apparatus according to claim 6, wherein the reporting device includes an air pressure supply state reporting portion that generates air pressure supply state report information based on the state of air pressure detected by the air pressure state detection device and reports the air pressure supply state report information if it is detected by the air pressure supply state detection device that air pressure is being supplied.

11. The air pressure state reporting apparatus according to claim 1, further comprising a tire temperature-related information obtainment device that is provided on at least one of the wheel and the vehicle body and that obtains tire temperature-related information that is information related to a temperature of the tire, wherein the reporting device includes a standard state air pressure obtaining portion that obtains the air pressure of the tire in a standard state based on the tire temperature-related information obtained by the tire temperature-related information obtainment device and the state of air pressure detected by the air pressure state detection device, and a set pressure attainment information reporting portion that reports that the air pressure of the tire in the standard state obtained by the standard state air pressure obtaining portion is at least a set pressure if the air pressure of the tire in the standard state obtained by the standard state air pressure obtaining portion is at least the set pressure.

12. The air pressure state reporting apparatus according to claim 11, wherein the tire temperature-related information obtainment device includes a rotation state detection device that detects a state of rotation of the wheel, and the reporting device includes a rotation state-corresponding temperature estimating portion that estimates a temperature of the tire based on the state of rotation detected by the rotation state detection device.

13. The air pressure state reporting apparatus according to claim 11, wherein the standard state air pressure obtaining portion includes a high temperature-time obtaining portion that obtains the standard state air pressure if the tire temperature indicated by the tire temperature-related information obtained by the tire temperature-related information obtainment device is at least a set temperature.

14. The air pressure state reporting apparatus according to claim 1, wherein the reporting device includes an inside reporting portion that reports the report information to inside the vehicle during a normal condition, and an outside reporting portion that reports the report information to outside the vehicle if it is detected by the air pressure supply state detection device that air pressure is being supplied.

15. The air pressure state reporting apparatus according to claim 14, wherein if the standard state air pressure reaches a target value, the outside reporting portion reports so, and if the standard state air pressure is lower than a reference value, the inside reporting portion reports so.

16. The air pressure state reporting apparatus according to claim 1, further comprising:
a wheel information transmitting portion that is provided on the wheel and that transmits wheel information that includes the state of air pressure detected by the air pressure state detection device; and
a receiving portion that is provided on the vehicle body and that receives the wheel information, wherein the reporting device includes a received information-based air pressure state obtaining portion that obtains the state of air pressure based on the wheel information received by the receiving portion.

17. The air pressure state reporting apparatus according to claim 1, wherein the reporting device is provided on the wheel.

18. The air pressure state reporting apparatus according to claim 1, wherein the reporting device includes a puncture repair state detection device that detects whether the tire is under a puncture repair.

19. An air pressure state reporting apparatus comprising:
an air pressure state detection device that is provided on a wheel and that detects a state of air pressure of a tire of the wheel;
an air pressure supply state detection device that detects whether air pressure is being supplied to the tire; and
an reporting device that generates report information indicative of an air pressure supply state based on the state of air pressure detected by the air pressure state detection device and reports the air pressure supply state report information generated, if it is detected by the air pressure supply state detection device that air pressure is being supplied.

20. An air pressure state reporting apparatus comprising:
an air pressure detection device that is provided on a wheel and that detects a value of air pressure of a tire of the wheel;
an air pressure supply state detection device that detects whether air pressure is being supplied to the tire;
an abnormality detection device that determines that there is an abnormality if a state where a gradient of change in the value of air pressure is at most a set gradient continues for at least a set time provided that it is detected by the air pressure supply state detection device that air pressure is being supplied; and
an abnormality reporting device that reports that there is an abnormality if the abnormality detection device detects so.

21. An air pressure state reporting apparatus comprising:
an air pressure detection device that is provided on a wheel and that detects a value of air pressure of a tire of the wheel; and
a standard state air pressure value obtaining portion that obtains a standard state air pressure value based on a detected air pressure value detected by the air pressure detection device and at least one of a load applied to the wheel and a temperature of the tire.

22. An air pressure reporting method comprising:
a first step of detecting a state of air pressure of a tire of a wheel; and
a second step of generating report information indicative of an air pressure state based on the state of air pressure detected, and reporting the report information generated to outside a vehicle.
